(19) United States
(12) Patent Application Publication
(10) Pub. No.: US 2009/0130445 A1
(43) Pub. Date: May 21, 2009

(54) Nanostructured enhancer

(76) Inventor: Henryk Malak, Ellicott City, MD (US)

Correspondence Address: H. Malak, 8444 High Ridge Road, Ellicott City, MD, 21043, US

(21) Appl. No.: 12/319,362

(22) Filed: Jan. 7, 2009

Related U.S. Application Data
(63) Continuation-in-part of application No. 10/930,608, filed on Sep. 1, 2004.
(60) Provisional application No. 60/559,059, filed on Apr. 5, 2004.

(51) Int. Cl. B32B 5/02; B01J 23/38; C09K 3/00

(52) U.S. Cl. 428/403; 428/402; 502/325; 252/182.33; 977/773

(57) ABSTRACT

A nanostructured enhancer of antimicrobial, hydrophilic, hydrophobic and catalytic properties is disclosed in the present invention. The nanostructured enhancer comprises a particle that has at least one pico- or nanometer innerstructured component that displays much higher antimicrobial, hydrophilic, hydrophobic and catalytic properties than the particle without the innerstructured component. The invention further describes the use of different type of energy sources to excite the innerstructured component to additionally increase the properties of the nanostructured particle.

### CROSS REFERENCE TO RELATED APPLICATIONS

This application is a Continuation in Part of the U.S. Provisional Patent Application No. 60/559,059 “Photocatalytic and Hydrophilic Properties of Materials Induced by Surface Plasmons and Application Thereof.” filed Apr. 5, 2004, and U.S. Non-Provisional patent application Ser. No. 10/930,608 entitled “A Method of Plasmon-Enhanced Properties of Materials and Applications Thereof” filed Sep. 1, 2004, which are herein incorporated by reference.

### STATEMENT REGARDING FEDERALLY SPONSORED RESEARCH

There is NO claim for federal support in research or development of this product.

### FIELD OF THE INVENTION

The herein disclosed invention finds applicability of nanotechnology in the field of sanitization, technology improvement and quality of human health.

### BACKGROUND OF THE INVENTION

There is a great need for anti-microbial agents that effectively kill microbes. However, current in use anti-microbial agents have significant limitations: they are chemical agents, they are toxic, their anti-microbial strength diminishes quickly in time, they do not kill all types of microbes, and some microbes quickly adapt to their anti-microbial agents, becoming more difficult to kill. Hence, there exists an unmet need for anti-microbial agents that have high strength, long lasting antibacterial properties, reduced microbe adaptability to anti-microbial agents, along with lower toxicity.

There are a few inventions related to antibacterial materials in which silver is embedded to these material fibers (U.S. Pat. No. 6,584,668, U.S. Pat. No. 6,087,549, U.S. Pat. No. 5,985,301, U.S. Pat. No. 5,876,489, U.S. Pat. No. 4,340,043). However, in these patents there is no mention of enhancing antibacterial properties of materials by engineering structures of the silver particles, inducing surface plasmon resonance effects in the silver particles or exciting the silver particles with other types of energy, and how to use metals other then silver or metal oxides with antibacterial properties of fabrics, what crucial role play the size and shape of embedded metal nanoparticles to fabrics on antibacterial properties of these fabrics.

There is also great need for “smart materials”, e.g. materials whose properties would be altered upon changes of physical parameters of environment surrounding these materials. Currently, there is a very modest success of applying the method of surface plasmon resonance to “smart materials”. The observed surface plasmon resonance-enhanced spectral changes upon changing environment of surrounding materials are within 50 nm, and the environmentally sensitive polymer covering metal nanoparticles alters its own properties upon changes in the environment, which leads to spectral changes of a plasmon absorption band. These modest spectral changes are good enough to built biochemical sensors, but not sufficient to apply them in “smart materials”, where drastic spectral changes would be desired. For example, there is great need to observe spectral changes by a few hundreds nanometers in glass windows upon sunlight heat, which can cause blocking infrared sunlight by glass window when temperature of the glass is to high. Hence, there is great need for new methods which significantly would change properties of materials.

The disclosed below invention shows a novel nanostructured enhancers to enhance properties of materials by many orders of magnitude, and how to overcome limitations of conventional agents to enable novel applications of nanostructured enhancers.

### SUMMARY DESCRIPTION OF THE PATENT

A nanostructured enhancer with enhanced antimicrobial, hydrophilic, hydrophobic and catalytic properties is disclosed in the present invention. The nanostructured enhancer comprises a particle that has at least one pico- or nanometer innerstructured component that displays much higher antimicrobial, hydrophilic, hydrophobic and catalytic properties than the particle without the innerstructured component. The disclosed enhanced properties of the nanostructured enhancer are also transferred to a material in which the nanostructured enhancer is embedded. The invention further describes the use of different type of energy sources to excite the innerstructured component that additionally enhances the properties of the nanostructured enhancer.

### BRIEF DESCRIPTION OF FIGURES

FIG. 1. An example of a 2-dimensional nanostructure of innerstructured components built inside a particle

FIG. 2. An example of a 2-dimensional nanostructure of innerstructured components built outside a particle

FIG. 3. An example of a 3-dimensional nanostructure of innerstructured components built outside a particle

### DETAIL DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

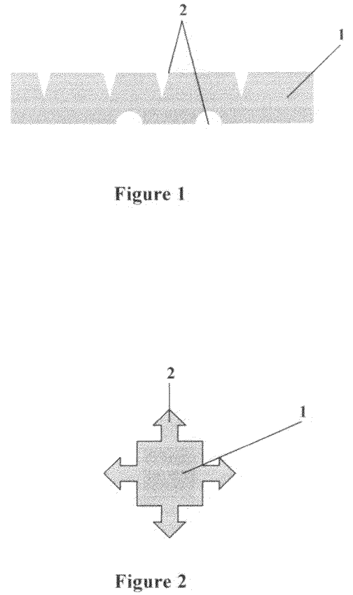

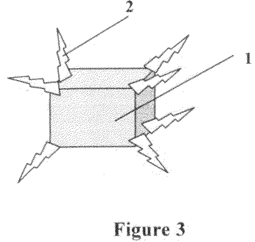

The present invention discloses a novel nanostructured enhancer displaying an enhanced antimicrobial, hydrophilic, hydrophobic or catalytic property in comparison to a particle without nanostructure. The nanostructured enhancer comprises of a particle and at least one innerstructured component that is inherent part of the particle. The innerstructured component (2) is placed inside the particle or outside the particle (1), as for example is shown on the FIG. 1 and FIG. 2. The innerstructured component can be fabricated on the particle or the innerstructured component can be selected from a naturally occurred particle. The innerstructured component can form a 2-dimensional structure or 3-dimensional structure on the particle (FIG. 3), and the size of the innerstructured component in these structures can be from piconanometers to nanometers. The shape and composition of these structures can be designed and fabricated or selected to enhance an antimicrobial, hydrophilic, hydrophobic or catalytic property of the nanostructured particle. The enhancement depends on strength and geometrical composition of electric and magnetic fields of the nanostructured enhancer.

The invention also discloses the use of different types of materials for the particle and innerstructured component, materials such as a conductive, semiconductive, dielectric, or any combination thereof. The selection of these materials to built the structures depends on the shape of the structures and on the application of the nanostructured particle, for example if an application is to kill bacteria or virus, it has to be known if bacteria or virus resides in water or in air, so dielectric nanostructured enhancer or conductive nanostructured enhancer can be used, respectively.

Another embodiment of the present invention proposes to use different types of energy to excite the nanostructured enhancer in order of further enhancement of the properties of the nanostructured enhancer. The energy may be selected from the group of: electromagnetic, ultrasound, thermal, electric, electrostatic, magnetic, or ionizing radiation. The electromagnetic energy source, emitting electromagnetic energy within the Ultraviolet to the Infrared range, is the most preferable source to use, since this energy source has the ability to induce surface plasmon resonance electric fields in the nanostructured enhancer. However, the use of electromagnetic Radio Frequency energy, particularly in use with conductive nanostructured enhancers, is also a favored option due to induced thermal energy in the nanostructured enhancers.

Another embodiment of the present invention proposes to use the nanostructured enhancer in different type materials to enhance or generated new properties of these materials. For example, in dielectric materials the nanostructured enhancers can induce hydrophobicity or hydrophilicity, which can remains in these materials for much longer than electric fields in the nanostructured enhancers.

The present invention also discloses an enhanced catalytic property of the nanostructured enhancers and the materials in which the nanostructured enhancers are embedded. Please note that the nanostructured enhancers can be made from noble metals, which display catalytic properties. But, the disclosed enhancement of catalytic property of the nanostructured enhancer is not only due to the increased surface of the nanostructured enhancer, but also due to nonlinear effects of electric fields induced in the nanostructured enhancer.

What is claimed is:

1. A nanostructured enhancer of an antimicrobial, hydrophilic, hydrophobic or catalytic property comprising of: a particle and at least one innerstructured component, wherein the innerstructured component is the inherent part of the particle.

2. The nanostructured enhancer of claim 1, wherein the particle and the innerstructured component are made of a single type of material or multiple type materials selected from the group of: conductor, semiconductor, or dielectric.

3. The nanostructured enhancer of claim 2, wherein the particle and the innerstructured component are made of the same type of the material or different type of the material.

4. The nanostructured enhancer of claim 1, wherein the particle has size within a range of 1 nm to 200,000 nm in at least one of its dimensions.

5. The nanostructured enhancer of claim 1, wherein the innerstructured component has size within a range of 0.01 nm to 20,000 nm in at least one of its dimensions.

6. The nanostructured enhancer of claim 1, wherein the innerstructured component is placed inside the particle or is outside the particle.

7. The nanostructured enhancer of claim 1, wherein the innerstructured component is fabricated in the particle or is selected from the naturally occurred particle.

8. The nanostructured enhancer of claim 1, wherein the innerstructured component is a 2-dimensional structure or a 3-dimensional structure.

9. The nanostructured enhancer of claim 8, wherein the 2-dimensional structure or 3-dimensional structure are designed or selected to enhance the antimicrobial, hydrophilic, hydrophobic or catalytic property of the particle.

10. The nanostructured enhancer of claim 1, wherein the particle is a single type particle or a plurality type particle.

11. The nanostructured enhancer of claim 1, wherein the innerstructured component is uncoated or is coated by a biochemical substance, biorecognitive substance, chemical-recognitive substance, polymer or chemical substance.

12. The nanostructured enhancer of claim 1, wherein the nanostructured enhancer is further embedded to a material to enhance the antimicrobial, hydrophilic, hydrophobic or catalytic property of the material.

13. The nanostructured enhancer of claim 12, wherein the material is selected from the group of: air, gas, liquid, polymer, or solid-state material.

14. The nanostructured enhancer of claim 1, wherein the nanostructured enhancer is further excited by a single type energy or a multiple types of energy to enhance the antimicrobial, hydrophilic, hydrophobic or catalytic property of the nanostructured particle, and the energy for the excitation is selected from the group of: electromagnetic, ultrasound, thermal, electric, electrostatic, magnetic, or ionizing radiation.
